(19) United States
(12) Patent Application Publication
(10) Pub. No.: US 2023/0210038 A1
(43) Pub. Date: Jul. 6, 2023

(54) SYSTEM AND METHOD FOR HYDRAULIC CONTROL OF A FINISHING ASSEMBLY

(71) Applicant: CNH INDUSTRIAL AMERICA LLC, Racine, WI (US)

(72) Inventors: Jared Paul Schaffer, Normal, IL (US); Timothy Richard Blunier, Danvers, IL (US)

(21) Appl. No.: 17/569,020

(22) Filed: Jan. 5, 2022

(51) Int. Cl. A01B 29/06; A01B 61/04; A01B 63/32

(52) U.S. Cl. CPC A01B 29/06; A01B 61/044; A01B 63/32; A01B 29/048

(57) ABSTRACT

A finishing assembly for an agricultural implement includes a first rolling basket and a second rolling basket. The finishing assembly also includes a basket support assembly coupled to the first rolling basket and the second rolling basket and configured to support the first rolling basket and the second rolling basket relative to each other. The finishing assembly further includes a linkage pivotably coupled to the basket support assembly at a first pivot point. The finishing assembly even further includes a hydraulic actuator pivotably coupled to the basket support assembly at a second pivot point, wherein the hydraulic actuator is configured to damp pivoting of the basket support assembly about the first pivot point in both a first pivot direction and a second pivot direction, the second pivot direction being opposite the first pivot direction.

### BACKGROUND

The present disclosure relates generally to finishing assemblies for agricultural implements.

It is well known that to attain the best agricultural performance from a piece of land, a farmer must cultivate the soil, typically through a tillage operation. Common tillage operations include plowing, harrowing, and sub-soiling. Farmers perform these tillage operations by pulling a tillage implement behind an agricultural work vehicle, such as a tractor. Depending on the crop selection and the soil conditions, a farmer may need to perform several tillage operations at different times over a crop cycle to properly cultivate the land to suit the crop choice.

Modem farm practices demand a smooth, level field with small clods of soil in the fall and spring of the year. In this regard, residue must be cut, sized, and mixed with soil to encourage the residue to decompose and not build up following subsequent passes of machinery. To achieve such soil conditions, it is known to utilize rolling baskets, such as crumbler reels, to produce smaller, more uniform clod sizes and to aid in the mixing of residue. In some instances, pairs of rolling baskets or “double-basket assemblies” are rigidly coupled to a portion of the implement frame to condition the field during each pass. However, in such instances, uneven pressure may be applied to the baskets of each double-basket assembly. To prevent such uneven pressure, the rolling baskets of each double-basket assembly are fixed relative to each other by a hanger that is pivotably coupled to a portion of the implement such that the rolling baskets are configured to pivot together relative to the frame of the implement to follow the ground contour with more even pressure on each basket. However, since the double-basket assembly is allowed to freely pivot, a harmonic oscillation effect may occur, which undesirably causes a “washboard” or bumpy finishing of the field.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In one embodiment, a finishing assembly for an agricultural implement is provided. The finishing assembly includes a first rolling basket and a second rolling basket. The finishing assembly also includes a basket support assembly coupled to the first rolling basket and the second rolling basket and configured to support the first rolling basket and the second rolling basket relative to each other. The finishing assembly further includes a linkage pivotably coupled to the basket support assembly at a first pivot point. The finishing assembly even further includes a hydraulic actuator pivotably coupled to the basket support assembly at a second pivot point, wherein the hydraulic actuator is configured to damp pivoting of the basket support assembly about the first pivot point in both a first pivot direction and a second pivot direction, the second pivot direction being opposite the first pivot direction.

In another embodiment, an agricultural implement is provided. The agricultural implement includes a frame member and a finishing assembly coupled to the frame member via a mounting bracket. The finishing assembly includes a first rolling basket and a second rolling basket. The finishing assembly also includes a basket support assembly coupled to the first rolling basket and the second rolling basket and configured to support the first rolling basket and the second rolling basket relative to each other. The finishing assembly further includes a linkage pivotably coupled to the basket support assembly at a first pivot point. The finishing assembly even further includes a hydraulic actuator pivotably coupled to the basket support assembly at a second pivot point, wherein the hydraulic actuator is configured to damp pivoting of the basket support assembly about the first pivot point in both a first pivot direction and a second pivot direction, the second pivot direction being opposite the first pivot direction.

In a further embodiment, a system is provided. The system includes a finishing assembly for an agricultural implement. The finishing system includes a first rolling basket and a second rolling basket. The finishing assembly also includes a basket support assembly coupled to the first rolling basket and the second rolling basket and configured to support the first rolling basket and the second rolling basket relative to each other. The finishing system further includes a linkage pivotably coupled to the basket support assembly at a first pivot point. The finishing system even further includes a mounting bracket, wherein the mounting bracket is configured to be fixed to a frame member of the agricultural implement, and wherein the linkage is coupled to the mounting bracket. The finishing system still further includes a downforce actuator pivotably coupled to the mounting bracket and the linkage. The finishing system yet further includes a hydraulic actuator pivotably coupled to the basket support assembly at a second pivot point. The system also includes one or more sensors coupled to components of the finishing assembly. The system further includes a controller communicatively coupled to the one or more sensors, wherein the controller is configured to selectively apply a biasing force, via the hydraulic actuator, to either the first rolling basket or the second rolling basket based on feedback from the one or more sensors.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement, in accordance with aspects of the present disclosure;

FIG. 2 is a perspective view of an embodiment of a finishing assembly, in accordance with aspects of the present disclosure;

FIG. 3 is a side view of a portion of the finishing assembly in FIG. 2, in accordance with aspects of the present disclosure;

FIG. 4 is a schematic view of an embodiment of an agricultural implement having the finishing assembly of FIG. 2 coupled to a work vehicle, in accordance with aspects of the present disclosure; and

FIG. 5 is a flow chart of a method for providing hydraulic control of a finishing assembly, in accordance with aspects of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed to a hydraulic control of a finishing assembly (e.g., double-basket assembly) of an agricultural implement. In particular, a hydraulic actuator (e.g., hydraulic cylinder) acts as a damping element to minimize back-and-forth oscillations of the finishing assembly about a pivot point. Minimizing the oscillations enables the finishing assembly to be utilized to make a smooth, level field with small clods of soil. In addition, the hydraulic actuator is configured to selectively apply a bias force to one of the baskets of the double-basket assembly based on feedback from sensors disposed throughout the finishing assembly.

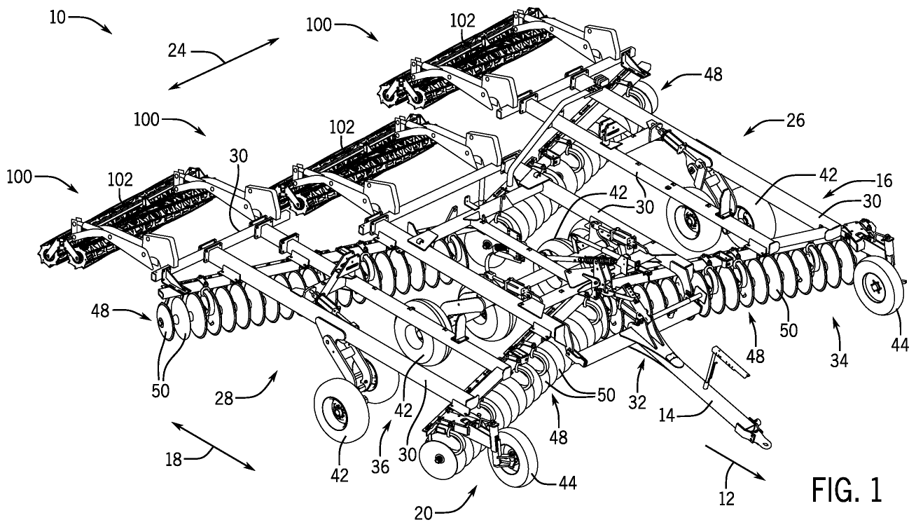

Referring now to the drawings, FIG. 1 illustrates a perspective view of an embodiment of an agricultural implement 10. In general, the implement 10 may be configured to be towed along a forward direction of travel 12 by a work vehicle (not shown), such as a tractor or other agricultural work vehicle. For example, the work vehicle may be coupled to the implement 10 via a hitch assembly 14 or using any other suitable attachments means. As shown, the hitch assembly 14 may be coupled to a frame 16 of the implement 10 to facilitate towing the implement 10 in the direction of travel 12.

As shown, the frame 16 may extend in a longitudinal direction (e.g., as indicated by arrow 18 in FIG. 1) between a forward end 20 and an aft end 22. The frame 16 may also extend in a lateral direction (e.g., as indicated by arrow 24 in FIG. 1) between a first side 26 and a second side 28. In addition, the frame 16 may generally include a plurality of structural frame members 30, such as beams, bars, and/or the like, configured to support or couple to a plurality of components.

In several embodiments, the frame 16 may include one or more sections. For example, as shown, in the illustrated embodiment, the frame 16 may include a main or center section 32 positioned centrally between the first and second sides 26, 28 of the frame 16. The frame 16 may also include a first wing section 34 positioned adjacent to the first side 26 of the frame 16. Similarly, the frame 16 may also include a second wing section 36 positioned adjacent to the second side 28 of the frame 16. The first and second wing sections 34, 36 may be pivotably coupled to the main section 32 of the frame 16. In this respect, the first and second wing sections 34, 36 may be configured to fold up relative to the main section 32 to reduce the lateral width of the implement 10 to permit, for example, storage or transportation of the implement 10 on a road. However, in other embodiments, the frame 16 may include any suitable number of frame sections.

The implement 10 may further include various wheel assemblies coupled to the frame 16 to support the frame 16 relative to the ground and to facilitate towing the implement 10 in the direction of travel 12. Specifically, in several embodiments, the implement 10 may include a plurality of center support wheel assemblies 42 located centrally on the frame 16 between its forward and aft ends 20, 22, with the wheel assemblies 42 being spaced apart from one another in the lateral direction 24 of the implement 10 between its first and second sides 26, 28. In addition, the implement 10 may also include a plurality of forward support wheel assemblies 44 coupled to the frame 16 adjacent to the forward end 20 of the frame 16, with the wheel assemblies 44 being spaced apart from one another in the lateral direction 24 of the implement 10 between its first and second sides 26, 28. As shown in FIG. 1, the forward support wheel assemblies 44 may be spaced apart from the center support wheel assemblies 42 in the longitudinal direction 18 of the implement 10. It should be appreciated that the implement 10 may include any suitable number and/or type of wheel assemblies in alternate embodiments.

Referring still to FIG. 1, the implement 10 may also include a plurality of ground-engaging tools supported by the frame 16. For example, in several embodiments, the frame 16 may be configured to support one or more gangs or sets 48 of disc blades 50 at its forward end 20. In such embodiments, each disc blade 50 may, for example, include both a concave side (not shown) and a convex side (not shown). Furthermore, the gangs 48 of disc blades 50 may be oriented at an angle relative to the travel direction 12 to promote more effective tilling of the soil. Additionally, as shown, in one embodiment, the implement 10 may also include one or more finishing assemblies 10, wherein the frame 16 may be configured to support the finishing assemblies 100 adjacent to its aft end 20. As will be described below, each finishing assembly 100 may include a pair of rolling baskets 102, which may, in turn, be configured to reduce the number of clods in the soil and/or firm the soil over which the implement 10 travels.

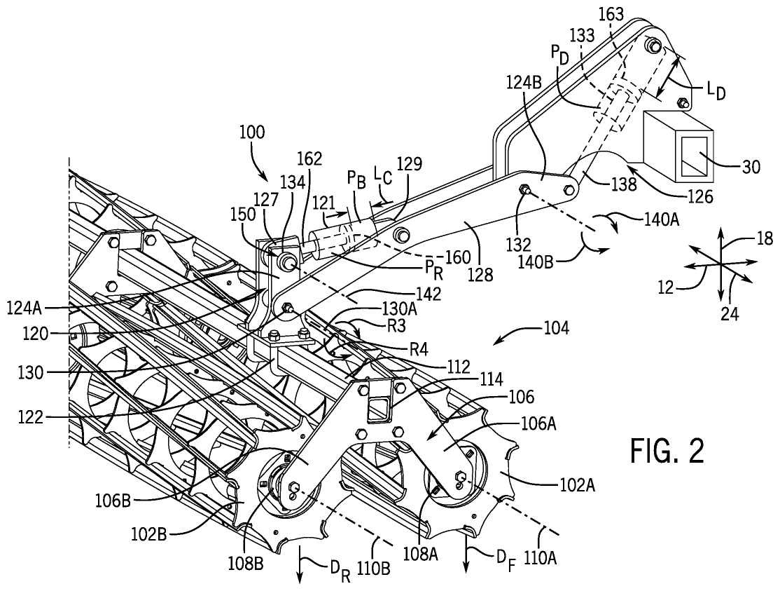

It should be appreciated that, in addition to the gangs 48 of disc blades 50 and the rolling baskets 102 of the finishing assemblies 100 shown in FIGS. 1 and 2 (or as an alternative thereto), the implement 10 may include any other suitable ground-engaging tools. For instance, if the implement 10 is configured as a cultivator or ripper, the implement 10 may include a plurality shanks, harrow tines, leveling blades, and/or the like.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

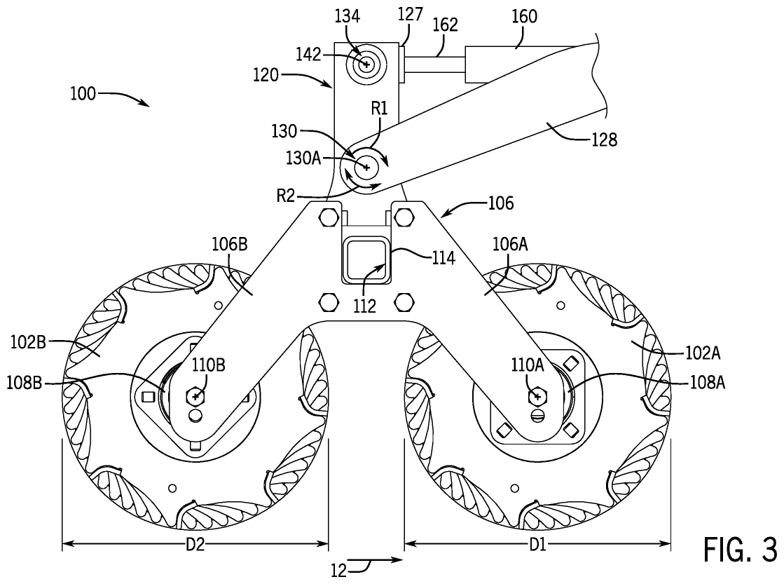

Referring now to FIGS. 2 and 3, various views of one embodiment of a finishing assembly (e.g., the finishing assemblies 100 shown in FIG. 1) are illustrated in accordance with aspects of the present subject matter. Specifically, FIG. 2 illustrates a perspective view of one of the finishing assemblies 100 described above with reference to FIG. 1, while FIG. 3 illustrates a side view of a portion of the finishing assembly shown in FIG. 2. It should be appreciated that, for purposes of discussion, the finishing assembly 100 will be generally described with reference to the tillage implement 10 shown in FIG. 1. However, those of ordinary skill in the art will readily appreciate that the disclosed finishing assembly 100 may be utilized with any suitable agricultural implements having any other suitable implement configuration(s).

In general, the finishing assembly 100 includes a pair of the rolling baskets 102. For instance, as particularly shown in the illustrated embodiment, the finishing assembly 100 includes a first rolling basket 102A and a second rolling basket 102B. In general, the rolling baskets 102A, 102B may have any suitable configuration that allows the baskets to generally function as described herein. As shown in FIG. 3, the first rolling basket 102A has a first diameter D1 and the second rolling basket 102B has a second diameter D2. In some embodiments the diameters D1, D2 of the rolling baskets 102A, 102B are the same. Additionally, as shown in the illustrated embodiment, the rolling baskets 102A, 102B are shown as having the same configuration, such as by being of the same basket type, i.e., single, formed bar basket type. However, in other embodiments, the diameters D1, D2 of the rolling baskets 102A, 102B, the basket type of the rolling baskets 102A, 102B (e.g., a flat bar roller, or a round bar roller), or both the diameter D1, D2 and basket type may differ between the first and second rolling baskets 102A, 102B. For instance, in one embodiment, the first rolling basket 102A may have a smaller diameter than the second rolling basket 102B.

As shown in the illustrated embodiment, the finishing assembly 100 may further include a basket support assembly 104 configured to support the rolling baskets 102A, 102B relative to each other. The basket support assembly 104 may generally include one or more hangers 106 configured to support the rolling baskets 102 for rotation relative to the ground, such as by including a hanger 106 at each of the opposed ends of the baskets 102. For example, as shown in the illustrated embodiment, each hanger 106 has a forwardly extending arm 106A relative to the direction of travel 12 of the implement 10, and a rearwardly extending arm 106B relative to the direction of travel 12 of the implement 10. In such an embodiment, the forward-most basket (e.g., the first rolling basket 102A) may be rotatably coupled to the forwardly extending arm 106A of the hanger 106 by a first rotational coupling 108A (e.g., a bearing(s) and associated mounting structure) such that the rolling basket 102A is rotatable about a first rotational axis 110A. Similarly, the rearward-most basket (e.g., the second rolling basket 102B) may be rotatably coupled to the rearwardly extending arm 106B of the hanger 106 by a second rotational coupling 108B (e.g., a bearing(s) and associated mounting structure) such that the rolling basket 102B is rotatable about a second rotational axis 110B spaced apart from the first rotational axis 110A along the direction of travel 12 of the implement 10. Additionally, the forwardly and rearwardly extending arms 106A, 106B of the hanger 106 are fixed relative to each other such that the rolling baskets 102A, 102B are supported in a fixed relationship relative to each other. More particularly, the rolling baskets 102A, 102B are supported relative to each other via the hanger 106 such that the rotational axes 110A, 110B of the first and second rolling baskets 102A, 102B are fixed relative to each other.

In the illustrated embodiment, the basket support assembly 104 further includes a toolbar 112 configured to support one or more of the hangers 106. More particularly, the toolbar 112 may be rigidly coupled to the hangers 106 of the rolling baskets 102A, 102B to support each hanger 106 relative to the ground. For example, in the illustrated embodiment, the toolbar 112 extends along the lateral direction 24 and is received within or extends through an opening 114 defined by each of the hangers 106. In such an embodiment, the toolbar 112 may be coupled to each hanger 106 at or adjacent to the location at which the toolbar 112 is received within or extends through the associated opening 114. The toolbar 112 may, in some embodiments, support hangers 106 for more than one pair of rolling baskets 102.

Additionally, as shown in the illustrated embodiment, the basket support assembly 104 includes a pivot bracket 120 fixedly coupled to the toolbar 112. For example, in some embodiments, the pivot bracket 120 is fixedly coupled to the toolbar 112 by one or more clamp bolts 122, each of which is received around the toolbar 112 and fixed at its ends to the pivot bracket 120. It should be appreciated, however, that in other embodiments, the pivot bracket 120 may be fixedly coupled to the toolbar 112 by any other suitable attachment means, such as by coupling the pivot bracket 120 to the toolbar 112 via welding.

Generally, the pivot bracket 120 may function to pivotably couple the basket support assembly 104 to a hydraulic actuator 121 (e.g., hydraulic cylinder) and a linkage 128 of the finishing assembly 100. More particularly, as shown in FIG. 2, the linkage 128 extends lengthwise between a first end 124A and a second end 124B. The first end 124A of the linkage 128 is pivotably coupled to the pivot bracket 120 of the basket support assembly 104 and the second end 124B of the linkage 128 is pivotably coupled to a mounting bracket 126 of the finishing assembly 100, with the mounting bracket 126 being fixedly coupled to a frame member 30 of the implement frame of the implement 10 (e.g., at the aft end of the implement 10).

The first end 124A of the linkage 128 is pivotably coupled at the first end 124A to the pivot bracket 120 at a pivot point 130, which defines a pivot axis 130A about which the basket support assembly 104 is configured to pivot relative to the hydraulic actuator 121 and the linkage 128. Specifically, as shown in FIG. 3, the basket support assembly 104 is pivotable in a first pivot direction R1 about the pivot axis 130A and in a second pivot direction R2 about the pivot axis 130A, with the second pivot direction R2 being opposite the first pivot direction R1. Additionally, as shown in the figures, given the configuration of the basket support assembly 104, the pivot point 130 is positioned higher than the first and second rolling baskets 102A, 102B in a vertical direction (e.g., as indicated by arrow 19 in FIG. 2). The linkage 128 is further pivotably coupled at the second end 124B to the mounting bracket 126 at a pivot point 132. Similarly, a first end 127 of the hydraulic actuator 121 is pivotably coupled to the pivot bracket 120 at a pivot point 134, which defines a pivot axis 142. The pivot point 134 is positioned higher than the pivot point 130 in the vertical direction 19, and opposite the toolbar 112. It should be appreciated that the pivot point 134 may be vertically aligned with the pivot point 130 along the vertical direction 19, as shown in FIG. 2, or may be offset from a vertical alignment with the pivot point 130, such as in the direction of travel 12. A second end 129 of the hydraulic actuator 121 is further pivotably coupled to the linkage 128 at a location 129 between the first end 124A and the second end 124B.

Additionally, as shown in FIG. 2, a downforce actuator 138 (e.g., hydraulic cylinder) may be provided to supply downforce to the basket support assembly 104. The downforce actuator 138 may generally be coupled between the mounting bracket 126 and the linkage 128 at the second end 124B of the linkage 128, such as at a location forward (e.g., relative to the frame member 30) of the pivot point 132 defined between the linkage 128A and the mounting bracket 126. In the illustrated embodiment, as a rod 133 associated with downforce actuator 138 is extended, the linkage 128 pivots about the pivot point 132 in a first rotational direction 140A, thereby raising the baskets 102A, 102B relative to the ground. Conversely, as the rod 133 associated with the downforce actuator 138 is retracted, the first linkage 128B pivots about the first pivot point 132 in a second rotational direction 140B (opposite the first rotational direction 140A), thereby lowering the baskets 102A, 102B into contact with the ground to apply a desired downforce to the baskets 102A, 102B (e.g., downward force D_{F} and downward force D_{R} to the forwards and rear baskets 102A, 102B, respectively).

The linkage 128 is coupled to the pivot bracket 120 via a fastener 150 positioned at the pivot point 134. The fastener 150 is configured to be pivotably received within the pivot bracket 120 such that the fastener 150 pivots about the pivot axis 142 relative to the pivot bracket 120. The fastener 150 extends through an opening in the end 127 of the hydraulic actuator 121.

In accordance with aspects of the present subject matter, to allow oscillations of the basket support assembly 104 to be at least partially damped or minimized during operation of the implement 10, the finishing assembly 100 further includes at least one damping element, the hydraulic actuator 121, provided in operative association with the basket support assembly 104. More particularly, in several embodiments, the hydraulic actuator 121 is configured to damp pivoting of the basket support assembly 104 about the pivot point 130 in both the first pivot direction R1 and the second pivot direction R2.

For example, when one of the baskets (e.g., the first basket 102A) encounters rocks or other impediments in the field, the basket support assembly 104 is urged to pivot about the pivot axis 130A in the second pivot direction R2. In such instance, the hydraulic actuator 121 may be configured to damp such pivotal motion. Similarly, when one of the baskets (e.g., the first basket 102A) encounters a drop in the field, the basket support assembly 104 will tend to pivot about the pivot axis 130A in the first pivot direction R1. In such instance, the hydraulic actuator 121 may be configured to damp such pivotal motion. As such, the hydraulic actuator 121 enables the rolling baskets 102A, 102B to work the ground more evenly when encountering changes in the field and to experience less oscillation for a shorter amount of time, which results in a smoother field surface. Additionally, the hydraulic actuator 121 “cushions” the impact caused by larger impediments or divots, which may be used to protect various elements of the finishing assembly 100.

In addition, the hydraulic actuator 121 is configured to selectively apply a biasing force (as the operator desires) to either the rolling basket 102A or the rolling basket 102B (i.e., apply more or all biasing force to one of the two rolling baskets 102A, 102B). As mentioned above, the downforce actuator 138 lowers the baskets 102A, 102B into contact with the ground to apply a desired downforce (D_{F}, D_{R}) to the baskets 102A, 102B. The hydraulic actuator 121 includes a base or piston 160 coupled to a rod 162. The piston 160 moves a distance or length, L_{C}, between a fully retracted position and an extended position due to pressures exerted on both sides of the piston 160 (e.g., pressure on rod side, P_{R}, and pressure on the base or piston side, P_{B}). The pressures P_{B} and P_{R} can be adjusted to provide a force bias to the forward basket 102A and the rear basket 102B and their associated downforces, D_{F} and D_{R}. For example, if P_{B} is greater than P_{R}, then a force bias is provided to the rear basket 102B. If P_{R} is greater than P_{B}, then a force bias is provided to the forward basket 102A. The force bias exerted by the hydraulic actuator 121 is balanced by a downforce pressure, P_{D}, within the downforce actuator 138 via engagement of the baskets 102A, 102B with the ground. A piston 163 (e.g., coupled to the rod 133) of the downforce actuator 138 moves a distance or length, L_{D}, between a fully retracted position and an extended position to set the P_{D}.

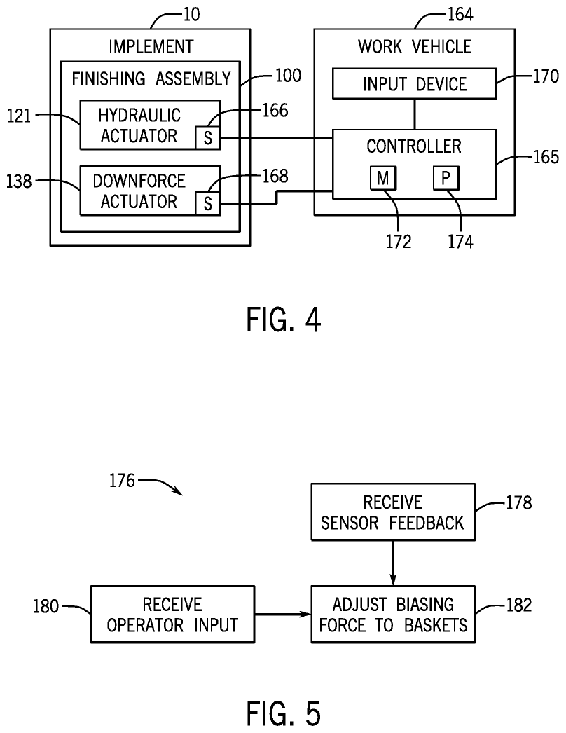

The force bias exerted by the hydraulic actuator 121 may be varied respect to L_{D} or L_{C} in conjunction with P_{D}. In certain embodiments, the hydraulic actuator 121 is configured to selectively apply a biasing force to either the rolling basket 102A or the rolling basket 102B based on feedback received from sensors associated with (coupled to or disposed within components of the finishing assembly 100). FIG. 4 is a schematic view of an embodiment of the agricultural implement 10 having the finishing assembly 100 of FIG. 2 coupled to a work vehicle 164 (e.g., tractor). The hydraulic actuator 121 includes one or more sensors 166 to detect parameters related to the hydraulic actuator 121. For example, the hydraulic actuator 121 may include a position sensor (e.g., Hall-effect linear-displacement transducer, magnetostrictive transducer, etc.) to detect L_{C}, which along with the geometry of the implement and the depth setting of the implement can be utilized to correlate the L_{C} to tillage depth. The hydraulic actuator 121 may include one or more sensors to determine the pressure(s) (e.g., P_{R}, P_{B}) within the hydraulic actuator 121. The hydraulic actuator 138 includes one or more pressure sensors 168 to detect parameters related to the downforce actuator 138. For example, the downforce actuator 138 may include a position sensor (e.g., Hall-effect linear-displacement transducer, magnetostrictive transducer, etc.) to detect L_{D}. The downforce actuator 138 may include a pressure sensor to determine P_{D}.

The work vehicle 164 includes a controller 165 communicatively coupled to the sensors 166, 168. The controller 165 is configured to receive feedback from the sensors 166, 168. The feedback relates to a position (L_{C}) of the hydraulic actuator 121, a pressure differential (e.g., between P_{R} and P_{B}) across the hydraulic actuator 121, a position (L_{D}) of the downforce actuator 138, and/or a pressure (P_{D}) in the downforce actuator 138. Based on this feedback, the controller 165 can control the positions of the hydraulic actuator 121 and the downforce actuator 138 (e.g. via actuators such as valve spools). By controlling the position of the hydraulic actuator 121 and/or the downforce actuator 138, the controller 165 can control how much biasing force is selectively applied to each of the baskets. In addition, the controller 165 can control the downforce exerted on the baskets. The controller 165 is also coupled to an input device 170 (e.g., touchscreen, switch, button, joystick, keyboard, etc.) that enables the operator to provide an input to control the finishing assembly 100 (e.g., selecting a particular basket to apply a biasing force to).

The controller 165 may include a memory 172 and a processor 174. In some embodiments, the processor 174 may include one or more general purpose processors, one or more application specific integrated circuits, one or more field programmable gate arrays, or the like. Additionally, the memory 172 may be any tangible, non-transitory, computer readable medium that is capable of storing instructions (e.g., related to applying biasing forces to the baskets based on sensor feedback, determining a position of a cylinder, determining a depth of the baskets, etc.) executable by the processor 174 and/or data that may be processed by the processor 174. In other words, the memory 172 may include volatile memory, such as random access memory, or non-volatile memory, such as hard disk drives, read only memory, optical disks, flash memory, and the like.

FIG. 5 is a flow chart of a method 176 for providing hydraulic control of a finishing assembly (e.g., finishing assembly 100 in FIGS. 2-4). One or more steps of the method 176 may be performed by a computing device (e.g., controller 165 in FIG. 4). One or more steps of the method 176 may be performed simultaneously or in a different order from that depicted in FIG. 5. The method 176 includes receiving feedback from sensors coupled to components of the finishing assembly (block 178). The sensors may be pressure sensors and/or positions sensors associated with a hydraulic actuator and/or downforce actuator of the finishing assembly as described above. The sensor feedback may include feedback related to a position of the hydraulic actuator, a pressure differential across the hydraulic actuator, a position of the downforce actuator, and/or a pressure in the downforce actuator. The method 176 may also include receiving an operator input (block 180). The operator input may relate to applying a biasing force to a particular basket of a double-basket assembly. The method 176 includes actively adjusting (or applying) a biasing force to either rolling basket of the double-basket assembly (block 182). Selectively adjusting or applying a biasing force to a particular basket of the double-basket assembly may include applying varying biasing force to one of the two rolling baskets. The selective application of a biasing force may be based solely on the received sensor feedback, solely based on the operator input, or a combination of the received sensor feedback and the operator input.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A finishing assembly for an agricultural implement, comprising:
a first rolling basket and a second rolling basket;
a basket support assembly coupled to the first rolling basket and the second rolling basket and configured to support the first rolling basket and the second rolling basket relative to each other;
a linkage pivotably coupled to the basket support assembly at a first pivot point; and
a hydraulic actuator pivotably coupled to the basket support assembly at a second pivot point, wherein the hydraulic actuator is configured to damp pivoting of the basket support assembly about the first pivot point in both a first pivot direction and a second pivot direction, the second pivot direction being opposite the first pivot direction.

2. The finishing assembly of claim 1, wherein the hydraulic actuator is configured to selectively apply a biasing force to either the first rolling basket or the second rolling basket.

3. The finishing assembly of claim 1, wherein the basket support assembly comprises a hanger configured to support the first rolling basket and the second rolling basket for rotation relative to the ground, a toolbar fixedly coupled to the hanger, and a pivot bracket coupled between the toolbar and a first end of the hydraulic actuator, the pivot bracket being pivotably coupled to a first end of the linkage at the first pivot point and the first end of the hydraulic actuator at the second pivot point.

4. The finishing assembly of claim 3, wherein a second end of the hydraulic actuator is pivotably coupled to the linkage.

5. The finishing assembly of claim 4, wherein the first pivot point is located above the second pivot point.

6. The finishing assembly of claim 4, comprising a mounting bracket, wherein the mounting bracket is configured to be fixed to a frame member of the agricultural implement, and wherein the linkage is coupled to the mounting bracket.

7. The finishing assembly of claim 6, comprising a downforce actuator pivotably coupled to the mounting bracket and a second end of the linkage.

8. The finishing assembly of claim 7, wherein the hydraulic actuator is configured to selectively apply a biasing force to either the first rolling basket or the second rolling basket based on feedback from one or more sensors coupled to components of the finishing assembly.

9. The finishing assembly of claim 8, wherein the feedback relates to a position of the hydraulic actuator, a pressure differential across the hydraulic actuator, a position of the downforce actuator, or a pressure in the downforce actuator.

10. The finishing assembly of claim 1, wherein the second pivot point is located above and forward of the first rolling basket and the second rolling basket.

11. An agricultural implement, comprising:
a frame member;
a finishing assembly coupled to the frame member via a mounting bracket, wherein the finishing assembly comprises:
a first rolling basket and a second rolling basket;
a basket support assembly coupled to the first rolling basket and the second rolling basket and configured to support the first rolling basket and the second rolling basket relative to each other;
a linkage pivotably coupled to the basket support assembly at a first pivot point; and
a hydraulic actuator pivotably coupled to the basket support assembly at a second pivot point, wherein the hydraulic actuator is configured to damp pivoting of the basket support assembly about the first pivot point in both a first pivot direction and a second pivot direction, the second pivot direction being opposite the first pivot direction.

12. The agricultural implement of claim 11, wherein the hydraulic actuator is configured to selectively apply a biasing force to either the first rolling basket or the second rolling basket.

13. The agricultural implement of claim 11, wherein the basket support assembly comprises a hanger configured to support the first rolling basket and the second rolling basket for rotation relative to the ground, a toolbar fixedly coupled to the hanger, and a pivot bracket coupled between the toolbar and a first end of the hydraulic actuator, the pivot bracket being pivotably coupled to a first end of the linkage at the first pivot point and a first end of the hydraulic actuator at the second pivot point, and a second end of the hydraulic actuator is pivotably coupled to the linkage.

14. The agricultural implement of claim 13, wherein the linkage is coupled to the mounting bracket.

15. The agricultural implement of claim 14, wherein the finishing assembly comprises a downforce actuator pivotably coupled to the mounting bracket and a second end of the linkage.

16. The agricultural implement of claim 15, wherein the hydraulic actuator is configured to selectively apply a biasing force to either the first rolling basket or the second rolling basket based on feedback from one or more sensors coupled to components of the finishing assembly.

17. The agricultural implement of claim 16, wherein the feedback relates to a position of the hydraulic actuator, a pressure differential across the hydraulic actuator, a position of the downforce actuator, or a pressure in the downforce actuator.

18. A system, comprising:
a finishing assembly for an agricultural implement, comprising:
a first rolling basket and a second rolling basket;
a basket support assembly coupled to the first rolling basket and the second rolling basket and configured to support the first rolling basket and the second rolling basket relative to each other;
a linkage pivotably coupled to the basket support assembly at a first pivot point;
a mounting bracket, wherein the mounting bracket is configured to be fixed to a frame member of the agricultural implement, and wherein the linkage is coupled to the mounting bracket;
a downforce actuator pivotably coupled to the mounting bracket and the linkage; and
a hydraulic actuator pivotably coupled to the basket support assembly at a second pivot point;
one or more sensors coupled to components of the finishing assembly; and
a controller communicatively coupled to the one or more sensors, wherein the controller is configured to selectively apply a biasing force, via the hydraulic actuator, to either the first rolling basket or the second rolling basket based on feedback from the one or more sensors.

19. The system of claim 18, wherein the one or more sensors comprise a first pressure sensor within the hydraulic actuator, a position sensor within the hydraulic actuator, a second pressure sensor within the downforce actuator, and a position sensor within the downforce actuator.

20. The system of claim 18, wherein the hydraulic actuator is configured to damp pivoting of the basket support assembly about the first pivot point in both a first pivot direction and a second pivot direction, the second pivot direction being opposite the first pivot direction.
